(19) United States
(12) Patent Application Publication
(10) Pub. No.: US 2006/0094551 A1
(43) Pub. Date: May 4, 2006

(54) Silent chain and method of producing same

(75) Inventor: Takashi Tohara, Osaka (JP)

Correspondence Address: HOWSON AND HOWSON;ONE SPRING HOUSE CORPORATION CENTER, BOX 457, 321 NORRISTOWN ROAD, SPRING HOUSE, PA, 19477, US

(73) Assignee: Tsubakimoto Chain Co., Osaka (JP)

(21) Appl. No.: 11/237,008

(22) Filed: Sep. 28, 2005

(30) Foreign Application Priority Data
Nov. 4, 2004 (JP) 2004-321202

(51) Int. Cl. F16G 13/04

(52) U.S. Cl. 474/212

(57) ABSTRACT

Occasional abnormal wear elongation, which occurs in a silent chain when exposed to lubricating oil in a deteriorated condition due to oxidation, is avoided by polishing the inner link plates of the chain to a surface roughness of 0.5 μm Rz or less, chromizing the inner link plates, forming a vanadium carbide layer on the connecting pins of the chain, and then polishing the connecting pins to a surface roughness of 0.5 μm Rz.

### FIELD OF THE INVENTION

This invention relates to silent chains for use in power transmissions, for example, the timing drives of automobile engines, and in various kinds of industrial machinery, conveying mechanisms, and the like.

### BACKGROUND OF THE INVENTION

In recent years, the use of silent chains has increased, especially in the timing chain of automobile engines where high operating speeds and heavy load conditions are encountered.

In general, a silent chain is composed of a set of guide link plates, inner link plates having engagement teeth for meshing with sprockets, and connecting pins. The connecting pins are fixed to the guide link plates by fitting into pin holes formed in the guide link plates. The pins, however, extend with a clearance through pin holes formed in the link plates, thereby allowing articulation of the chain. In a silent chain, since the teeth of the inner link plates slide along the teeth of a sprocket from the time when they come into contact with the sprocket teeth to the time when they separate from the sprocket teeth, impact noise due to collision between the sprocket and the chain is reduced and the overall noise level produced during operation of the transmission is comparatively low.

In a conventional silent chain, alloy steel and high carbon steel have been used as the base materials of the connecting pins and link plates because of their availability and low cost. The surfaces of the connecting pins are subjected to heat treatment, such as carburization or carbonitriding, to suppress wear.

In addition to the heat treatment of the surface of the connecting pin, it has been proposed, in Japanese Laid-open Patent Publication 2000-249196, for example, to subject a surface of the link plate to a surface-hardening treatment, such as nitriding or diffusion coating, to suppress wear of the link plate.

However, it has been reported that some chains do not have the expected wear resistance, and exhibit abnormal wear in spite of the surface treatments of the connecting pins and the link plates. Elimination of this abnormal wear is urgently needed to improve engine reliability.

### BRIEF SUMMARY OF THE INVENTION

Excessive wear of the walls of the pin holes of the inner link plates is generated when the engine lubricating oil in the engine deteriorates through oxidation, and its pH falls to a level below 3. In addition, when the base materials of the connecting pin and the inner link plate are the same, the base materials are liable to bind together, further promoting wear of the chain. An object of the invention, therefore, is to provide a silent chain, which maintains its flexibility and operates smoothly, and without abnormal wear elongation, over a long period of time, even when used in lubricating oil which has deteriorated as a result of a high degree of oxidation.

In the silent chain in accordance with the invention, carbon steel inner link plates are polished by barrel tumbling before heat treatment so that their surface roughness is 0.5 μm Rz or less. After the links are polished, they are subjected to a chromizing treatment. A vanadium carbide layer is formed on the surfaces of the connecting pins, and the pins are then polished by barrel tumbling so that their surface roughness is also 0.5 μm Rz or less. In the assembled chain, the connecting pins are fitted into, and fixed to, the pin holes of the guide link plates, but extend through the pin holes of the inner link plates with a clearance.

A powdered, liquid, or gaseous plating metal can be made to diffuse into a heated base-metal surface. In the chromizing treatment of the invention, metallic chromium is diffusion-coated onto steel, preferably by a powder pack process, in which the inner link plates, composed of carbon steel, are heated in a diffusion material preferably composed of a mixture of chromium, alumina as an antisintering agent, and ammonium chloride (NH₄Cl) as a reaction accelerator. The powder pack process forms chromium carbide on the surfaces of the inner link plates.

The chromizing treatment, to which the surfaces of the inner link plates is subjected, resists corrosion due to exposure to oxidized and deteriorated oil. Furthermore, the vanadium carbide layer, formed on the surface of the connecting pin, is disposed between the chromium on the surface of the link plate and the chromium contained in the connecting pin, so that binding resulting from mutual contact between similar elements is reduced.

Polishing the surfaces of the connecting pins to a low surface roughness improves the ability of the pins to slide relative to the surfaces of the holes in the inner link plates, thereby reducing wear. Smoothness of the surfaces of the sliding materials is important not only in order to reduce mechanical wear, but also to reduce the susceptibility of the surfaces to chemical attack. It has been determined experimentally that, when the surface roughness is 0.5 μm Rz or less, a significant reduction in wear and chemical deterioration is realized. The silent chain according to the invention is maintains its flexibly, and operates smoothly over a long period of time without abnormal wear elongation, even in the corrosive environment of deteriorated lubricating oil.

### BRIEF DESCRIPTION OF THE DRAWINGS

FIG. 1 is a perspective view showing a portion of a silent chain in accordance with invention; and

FIG. 2 is a table showing the results of wear resistance tests on the silent chain of the invention in wear acid oil.

### DETAILED DESCRIPTION OF THE PREFERRED EMBODIMENTS

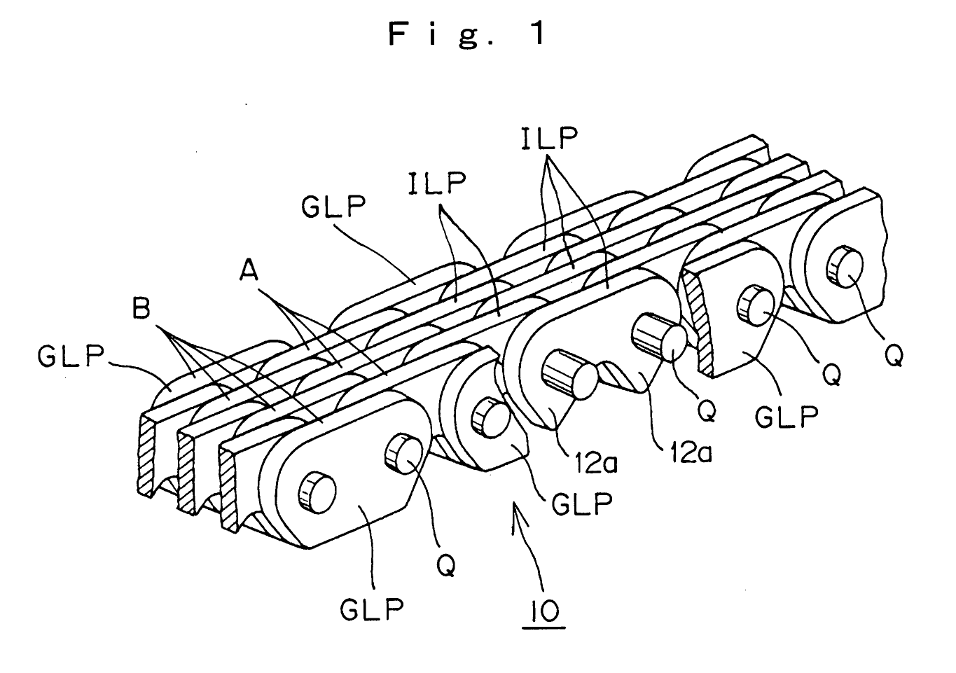

In FIG. 1, the inner structure of the silent chain 10 is shown by cutting away parts of two guide link plates GLP on the front side of the chain. Inner link plates ILP, each having two teeth 12a, are connected to one other in interleaved relationship to form an endless loop. Alternate rows of plates in the chain have even and odd numbers of inner link plates, respectively. The chain 10 is composed of a guide row B, having two inner link plates ILP and two guide link plates GLP, and a joint row A, composed of three inner link plates ILP. The guide link plates GLP, at the ends of the guide link rows, are fixed to the connecting pins P, and do not have teeth.

Although, in the embodiment depicted in FIG. 1, each guide row B has two inner link plates ILP and each row A has three inner link plates ILP, the number of plates can be increased or decreased according to the required load capability of the chain. For example the chain can be composed of guide rows each having four inner link plates and two guide link plates, and joint rows each composed of five inner link plates.

Each inner link plate ILP is composed of carbon steel, subjected to polishing by barrel tumbling before heat treatment, so that its surface roughness, including the surface roughness of the cylindrical walls of its pin holes, is 0.5 μm Rz or less. After polishing, the inner link plates ILP are subjected to chromizing treatment. The chromizing treatment produces a chromium carbide layer on the cylindrical walls of the pin holes as well as on the other surfaces of the inner link plates. Polishing of the inner link plates should be carried out before chromizing so that the surfaces of the link plates, especially the inner surfaces of the holes through which the connecting pins extend, are made sufficiently smooth to be chromized adequately.

Vanadium carbide layers are formed on the surfaces of the connecting pins, and the connecting pins are then polished, by barrel tumbling, so that their surface roughness is also 0.5 μm Rz or less.

A chain in accordance with the invention was compared to five other silent chains, namely, a conventional silent chain and four additional examples. In the conventional silent chain the connecting pins were subjected only to the formation of a vanadium carbide layer, but were not polished. The inner link plates were not subjected to polishing or chromizing. Reference example 1 is a silent chain in which the connecting pins were subjected only to polishing without the formation of a vanadium carbide layer and in which the inner link plates were subjected to both polishing and chromizing. Reference example 2 is a silent chain in which the connecting pins were subjected only to the formation of a vanadium carbide layer without polishing, and in which the inner link plates were subjected to both polishing and chromizing. Reference example 3 is a silent chain in which the connecting pin were subjected both to the formation of a vanadium carbide layer and to polishing, but in which the inner link plates were subjected only to chromizing without polishing. Reference example 4 is a silent chain in which the connecting pins were subjected both to the formation of a vanadium carbide layer and to polishing, and the inner link plate were neither polished nor subjected to chromizing treatment.

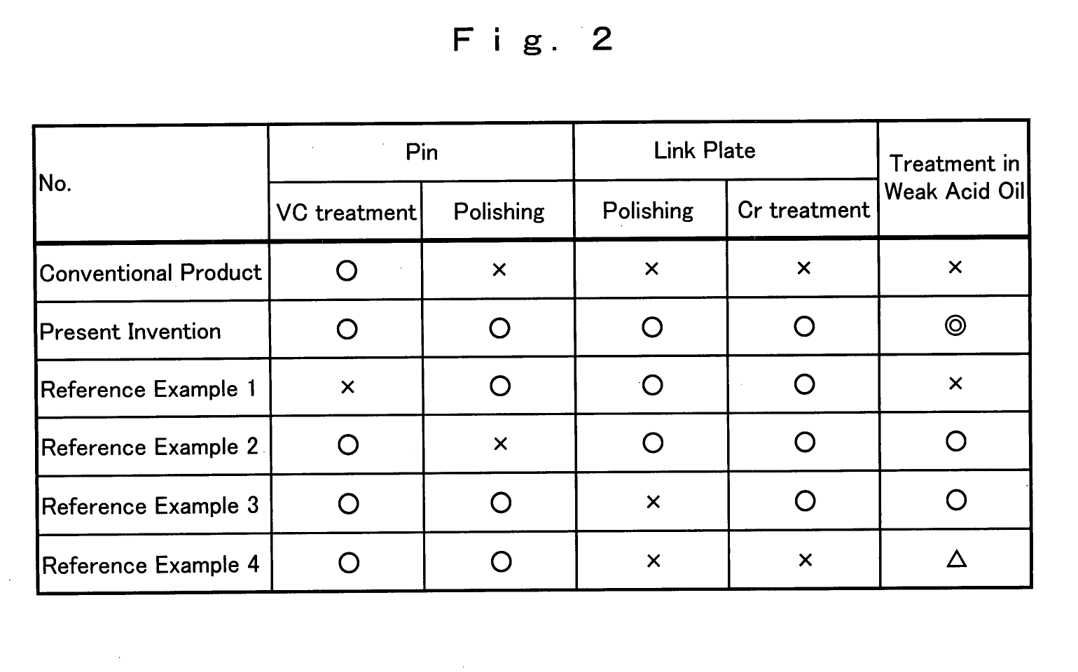

Elongation of the respective chains, after being operated in weak acid oil, was determined, and the results are shown in the right-hand column of FIG. 2. In the first four columns, the symbol ◯ indicates that the treatment in the column heading was applied, and the symbol X indicates that the treatment in the column heading was not applied. In the right-hand column, the symbols X, Δ, ◯ and ⊚ indicate respectively better performance in terms of chain elongation, X indicating poor performance, and ⊚ indicating superior performance.

As apparent from FIG. 2, the chain in accordance with the invention, comprising inner link plates and connecting pins produced by the above-described treatments exhibited less elongation in weak acid oil compared with the conventional product and reference examples 1 to 4.

In accordance with the invention, when polishing and surface treatment of the base materials of the inner link plates and connecting pins are carried out as described, abnormal wear elongation in deteriorated oil is reproducibly avoided, and consequently the invention has broad and significant industrial applicability.

What is claimed is:

1. A silent chain comprising guide link plates, connecting pins fitting into pin holes of said guide link plates and fixed thereto, and inner link plates having engagement teeth, in which said connecting pins extend through pin holes of said inner link plates with a clearance, in which said inner link plates carbon steel link plates having a chromium carbide coating and a surface roughness of 0.5 μm Rz or less, and in which the surfaces of the connecting pins have a vanadium carbide layer and a surface roughness of 0.5 μm Rz or less.

2. A silent chain comprising guide link plates, connecting pins fitting into pin holes of said guide link plates and fixed thereto, and inner link plates having engagement teeth, in which said connecting pins extend through pin holes of said inner link plates with a clearance, in which said inner link plates are produced by polishing carbon steel link plates by barrel tumbling the link plates before heat treatment to make the surface roughness of said inner link plate 0.5 μm Rz or less, subjecting the polished link plates to chromizing treatment, and in which the connecting pins are produced by forming a vanadium carbide layer on the surfaces of pins, and thereafter polishing the connecting pins by barrel tumbling to make the surface roughness of the connecting pins 0.5 μm Rz or less.

3. A method of producing a silent chain comprising:
barrel tumbling inner link plates composed of carbon steel before heat treatment thereof, thereby polishing the link plates to a surface roughness of 0.5 μm Rz or less;
subjecting the polished link plates to chromizing treatment;
forming a vanadium carbide layer on the surfaces of connecting pins;
after forming the vanadium carbide layer on the surfaces of said connecting pins, barrel tumbling the connecting pins, thereby polishing the surfaces of the connecting pins to a surface roughness of 0.5 μm Rz or less; and
assembling a chain by passing said pins through pin holes in said inner link plates with a clearance, and fitting said pins into pin holes in guide link plates, thereby fixing the pins to the guide link plates.
